(19) United States
(12) Patent Application Publication
(10) Pub. No.: US 2025/0202776 A1
(43) Pub. Date: Jun. 19, 2025

(54) DATA COMPLIANCE SYSTEM AND METHOD

(71) Applicant: Microsoft Technology Licensing, LLC, Redmond, WA (US)

(72) Inventors: Anthony HOCK-KOON, Mougins (FR); Dorota FILIPCZUK, Oslo (NO); Therese Nesseth TØRLEN, Langevåg (NO)

(73) Assignee: Microsoft Technology Licensing, LLC, Redmond, WA (US)

(21) Appl. No.: 18/539,443

(22) Filed: Dec. 14, 2023

(51) Int. Cl. H04L 41/16; H04L 41/084

(52) U.S. Cl. CPC H04L 41/16; H04L 41/084

(57) ABSTRACT

A method of and system for method for ensuring data compliance in a computer environment includes retrieving data rules from a rule repository, the rule repository being a repository that stores one or more rules that are associated with storage or transfer of data by one or more devices in the computing environment, retrieving metadata about data flow in the computing environment from a policy governor, retrieving information about a data classification of data used by one or more services provided by the computing environment, and retrieving data about a network topography of the computing environment. The retrieved data is then used to generate a configuration file for configuring a Field Programmable Gate Array (FPGA) based on at least one of the retrieved data. The configuration file is transmitted to an FPGA configuration loader for loading the configuration file onto the FPGA, where the FPGA utilizes the configuration file to implement the data rules in the computing environment to ensure compliance with the rules.

### BACKGROUND

Software application providers and in particular providers that offer software as a service and/or other computer system providers often need to comply with a number of rules, regulations and policies regarding the transfer and storage of data. For example, software service providers are required to ensure that data storage and transfer complies with geographical and regional rules and regulations regarding data storage and transfer. As an example, some countries or geographical locations have specific rules regarding storage of customer data. In another example, some countries prohibit transfer of customer data from geographic location to another (e.g., from Europe to South America).

In order to comply with these rules and policies, some service providers use software applications that detect data transfers and/or data storage attempts that violate a rule or policy. This approach requires a lot of computing and network resources. Furthermore, the process of checking for and detecting violations using software mechanisms takes a lot of time, thus slowing the overall process of transferring and/or storing data. Furthermore, existing systems for detecting and/or blocking violating data transfers and/or data storage, require a manual and time-consuming process of generating documentation.

Hence, there is a need for improved systems and methods of ensuring data compliance.

### SUMMARY

In one general aspect, the instant disclosure describes a data processing system having a processor and a memory in communication with the processor, where the memory comprises executable instructions that, when executed by the processor, cause the data processing system to perform multiple functions. These functions include retrieving data rules from a rule repository, the rule repository being a repository that stores one or more rules that are associated with at least one of storage or transfer of data by one or more devices in a computing environment; retrieving metadata about data flow in the computing environment from a policy governor; retrieving information about a data classification of data used by one or more services provided by the computing environment; retrieving data about a network topography of the computing environment; generating a configuration file for configuring a Field Programmable Gate Array (FPGA) based on at least one of the data rules, the metadata, the data about the network and the information about the data classification of data used by the one or more services provided by the computing environment; and transmitting the configuration file to an FPGA configuration loader for loading the configuration file onto the FPGA, wherein the FPGA utilizes the configuration file to implement the data rules in the computing environment.

In another general aspect the instant disclosure describes a method for ensuring data compliance in a computer environment. The method includes retrieving data rules from a rule repository, the rule repository being a repository that stores one or more rules that are associated with at least one of storage or transfer of data by one or more devices in the computing environment; retrieving metadata about data flow in the computing environment from a policy governor; retrieving information about a data classification of data used by one or more services provided by the computing environment; retrieving data about a network topography of the computing environment; generating a configuration file for configuring an FPGA based on at least one of the data rules, the metadata, the data about the network and the information about the data classification of data used by the one or more services provided by the computing environment; and transmitting the configuration file to an FPGA configuration loader for loading the configuration file onto the FPGA, wherein the FPGA utilizes the configuration file to implement the data rules in the computing environment to ensure data compliance in the computing environment.

In yet another general aspect, the instant disclosure describes a non-transitory computer readable medium on which are stored instructions that when executed cause a programmable device to perform functions of retrieving data rules from a rule repository, the rule repository being a repository that stores one or more rules that are associated with at least one of storage or transfer of data by one or more devices in a computing environment; retrieving metadata about data flow in the computing environment from a policy governor; retrieving information about a data classification of data used by one or more services provided by the computing environment; retrieving data about a network topography of the computing environment; generating a configuration file for configuring an FPGA based on at least one of the data rules, the metadata, the data about the network and the information about the data classification of data used by the one or more services provided by the computing environment; and transmitting the configuration file to an FPGA configuration loader for loading the configuration file onto the FPGA, wherein the FPGA utilizes the configuration file to implement the data rules in the computing environment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an example system upon which aspects of this disclosure may be implemented.

FIG. 2 is an example of data flow between some elements illustrated in and other elements used by the system illustrated in FIG. 1.

FIG. 3 is an example of some elements involved in generating a data compliance document for a computing system.

FIG. 4 is a flow diagram showing an example method for ensuring data compliance in a computer environment.

FIG. 5 is a block diagram illustrating an example software architecture, various portions of which may be used in conjunction with various hardware architectures herein described.

FIG. 6 is a block diagram illustrating components of an example machine configured to read instructions from a machine-readable medium and perform any of the features described herein.

### DETAILED DESCRIPTION

Software service providers such as Microsoft® are often required to ensure that their computing platforms have mechanisms for safeguarding data security and privacy. This often involves compliance with certain data privacy rules, regulations and policies. Furthermore, some governments and/or other entities have specific rules regarding transfer and/or storage of data. As such, organizations that provide services that involve storage and/or transfer of data are required to ensure compliance with many rules, regulations and/or policies regarding the transfer and/or storage of data. Currently, some service providers use software mechanisms for providing the required data security and privacy. For example, some organizations use a software that is deployed in collocation with the business application software that the organization uses. In another example, some organizations use a software application that is an independent remote service. Both of these approaches have a performance impact on the business application. A collocated approach means that the server that executes the business application needs to dedicate time and computing resources to compute the data violation checks. An independent service requires the business application to send a request to the service which adds an extra network hop, thus taking more time and requiring more network and computing resources. These approaches negatively impact the response time. Furthermore, these conventional systems consume general processing and computing cycles. Thus, there exists a technical problem of lack of efficient mechanisms for ensuring compliance with data rules and regulations in a computing platform.

In addition to ensuring compliance with the required rules, regulations and policies, most service providers are also required to keep track of their compliance efforts. Moreover, most service providers are interested in learning about the status of their compliance efforts. This involves a manual audit and reporting process. For large organizations, the size of the data transferred and/or stored and the number of data violation checks, etc. make any audit or documentation effort very time-consuming and difficult. Furthermore, since documentation and computing systems are evolving in parallel, it is challenging to guarantee total consistency between the state of the computing platform and the documentation. Thus, there exists another technical problem of lack of mechanisms for efficiently and accurately documenting data compliance efforts.

To address these technical problems and more, in an example, this description provides a technical solution for incorporating data rules and policies into Field Programmable Gate Arrays (FPGA) in a computer infrastructure such that the FPGAs can directly implement the data rules in routing data and to utilize the configuration data provided to the FPGAs to generate documentation on data violation checks. This involves use of a system architecture that includes a FPGA configuration generator, policy and rule extractors, and a single source of truth (SSOT) extractor that extracts information about the type of data handled by different applications in the computer infrastructure. The policy and rules extractors may extract applicable rules, policies and regulations from their respective sources. The SSOT extractor extracts information about the type of data handled by different applications from various data sources associated with the applications. The extracted data is collected and configured for use by an FPGA which uses the configuration data to directly handle data transmission and storage requests. Thus, the technical solution makes use of hardware device to directly implement data rules in a computer infrastructure, thus obviating the need for use of software applications.

The technical solution described herein addresses the technical problem of inefficiency of current data compliance mechanisms in ensuring compliance with data transfer and data storage rules and policies, and in generating documentation on the compliance. The technical solution provides an efficient and accurate mechanism for ensuring a computer environment complies with data rules without the need to affect business application software or the need to use a remote service. The technical advantage includes the use of one or more FPGAs to directly route data in accordance with data rules implemented in the FPGA, instead of having the cloud services that manage the data make these determinations using computing cycles. The technical effects at least include (1) improving the operation of computing systems by reducing the amount of network traffic and computing resources needed to ensure compliance with data rules; (2) reducing the amount of user time and resources required to generate documentation regarding data compliance; and (3) improving the accuracy of compliance documentation by utilizing a reporting manager that takes in authorization configuration data and automatically generates data handling reports for compliance purposes.

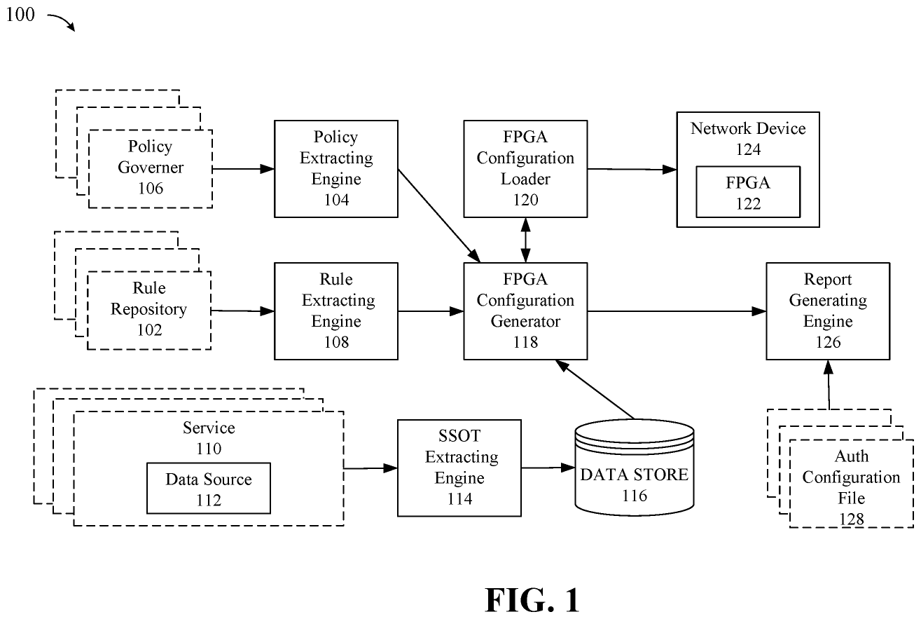

FIG. 1 illustrates an example system 100, upon which aspects of this disclosure may be implemented. The system 100 includes a policy extracting engine 104, rule extracting engine 108, SSOT extracting engine 114, data store 116, FPGA configuration generator 118, FPGA configuration loader 120, and a report generating engine 126. The system 100 also includes a network device 124 which itself includes an FPGA 122.

To ensure that data transfers handled by the computing system 100 comply with data rules, the system needs to assure that any data transferred by the system does not violate rules and regulations that apply to that data. Rules that apply to data may include region-specific rules and regulations such as those imposed by lawmakers and/or regulators such as the European Union, and data specific policies, such as policies set by a tenant administrator. The region-specific rules often dictate whether a data transfer is allowed from and to specific geographical regions. Data policies may govern parameters such as time intervals in which data can be transferred to/from logical regions (e.g., geographical, or classes of devices). In some implementations, to ensure compliance, the system considers the entity that initiates the data transfer and the classification of the data being transferred. The entity that initiates the data transfer may be a user (e.g., the transfer occurs in response to a user query), administrator initiated (e.g., the transfer occurs in response to an action initiated by an administrator), or feature/system initiated (e.g., the transfer is initiated by some feature to, for example, prime caches close to the user to reduce latencies for queries expected to come from the user). The classification of the data is used in instances where there are specific rules regarding certain types of data. For example, while transfer of system metadata is allowed in most cases, data that is considered sensitive or related to customer content is often subject to more restrictive rules.

Additionally, most computer systems need to ensure that they comply with data storages rules and requirements. For example, software service providers need to comply with rules and regulations that govern where particular categories of data can be stored. In an example, where storage of system metadata is not restricted in most cases, storage of data that is considered confidential or private is often subject to more restrictive rules. Additionally, depending on the classification of data, different encryption requirements may apply. Furthermore, data may be subject to data retention/life-time requirements. For example, depending on the classification of data, it may be allowed to temporally cache the data for short periods of time, while permanently storing it may be prohibited. Still further, specific organization (e.g., tenant) policies may govern data storage. Such policies could govern, for example, in which logical regions (e.g., geographical) storage is permitted and in which regions it is prohibited.

To ensure data compliance, the system 100 needs to detect, reject and/or notify administrators of any data transfer or storage attempts that violate one of the applicable rules or policies. This is achieved by first extracting a list of the applicable rules and policies, and then configuring the FPGA 122 using the extracted rules and policies. To do this, the policy extracting engine 104 extracts metadata about the data flow in the system 100. For example, the metadata may include information that indicates whether a given data flow is user or service initiated. The metadata is extracted from the policy governors 106, which stores metadata associated with data flowing in the system 100. Different services and applications are governed by different data flow policies. For example, data flows initiated by some services are considered user initiated, while others are considered platform/feature initiated. Still others are considered administrator initiated. A policy governor is often responsible for ensuring the correct rules are applied by the system to the correct data. This is done by providing the rule set and/or contract that should be employed. Thus, the policy governor 106 stores specific sets of policies that may apply to the system 100. The policy extracting engine 104 extracts metadata about the data flow, such as user or service-initiated flow, from existing policy governors 106.

In addition to the policy extracting engine 104, the system 100 makes use of a rule extracting engine 108 which retrieves information from existing rule repositories 102 to obtain the set of rules currently applicable by the associated runtime systems. That is because rules and regulations are subject to change. Changes might occur due to contractual agreements, privacy laws, and/or political arrangements. To ensure compliance with the latest rules, the rule repositories 102 are used to extract the latest applicable rules. The rule repository 102 may function as a central rule repository of the various rules applicable to the system 100. Whenever a rule changes, the rule repository 102 is updated accordingly. It should be noted that multiple rule repositories 102 can be maintained and owned by different parties. For example, the European Union (EU) might operate a rule repository 102 containing rules and regulations governing data storage and/or transfer rules that apply to EU citizens, while an organization may have a separate rule repository 102 of policies that apply to internal and/or cross-tenant data storage and/or transfer. For any data transfer and/or storage, rules from multiple rule repositories 102 may have to be considered. By extracting the rules from the rule repositories 102, the rule extracting engine 108 is able to retrieve the various rules that currently apply to transfer/storage of data by the system 100.

Because many of the data transfer/storage rules are associated with the type of data being transferred/stored, the system 100 also extracts information about classification of data. This is achieved by the SSOT extracting engine 114, which extracts data classification and/or data type information from data sources 112. The data sources 112 are heterogeneous sources that are associated with one or more services 110, which are services that are executed/offered by the system 100. Each service 110 may be a software service offered by or executed by the system 100. The SSOT extracting engine 114 extracts data classification data from the data sources 112 to generate an SSOT for the system 100 which it transmits to the data store 116 for storage and/or publication. In some implementations, the SSOT is generated in one homogenous format. Each of the policy extracting engine 104, rule extracting engine 108 and SSOT extracting engine 114 is a service that may be stored and/or executed on a server and calls a particular data repository to retrieve the data required. The policy extracting engine 104, rule extracting engine 108 and SSOT extracting engine 114 are offline services.

Once the rules, policies and SSOTs are extracted, the extracted data is provided by each of the of the policy extracting engine 104, rule extracting engine 108 and SSOT extracting engine 114 to the FPGA configuration generator 118. The FPGA configuration generator 118 collects the received rules, policies and SSOTs and uses the collected data to generate a configuration file for a given FPGA 122. A system such as the system 100 may include multiple FPGAs each of which may be used in a different network device 124. The FPGA configuration generator 118 generates different configurations for each FPGA based on the location of the network device 124 each FPGA is used in. To achieve this, the FPGA configuration generator 118 receives information about the network topology from the FPGA configuration loader 120. The FPGA configuration loader 120 retrieves the network topology from the network devices available in the system. The network topology guides the configuration generation done by the FPGA configuration generator 118. The generation is based on the regional availability of the services, their application programming interface (API) syntaxes, and the violation rules that apply to each region. This is done to ensure that each FPGA only has the minimum set of rules necessary to handle the services that are accessible through each network device 124. This ensure efficiency and decreases latency. Thus, FPGA configuration generator 118 examines data about the FPGA 122 (e.g., the location of the FPGA or the services it is responsible for handling), which may be received from the FPGA loader 120, and examines the rules, policies and SSOTs to determine which rules and policies apply to the FPGA 122. Based on this, the FPGA configuration generator 118 generates a configuration file for the FPGA 122 that can configure the FPGA 122 to detect and/or block data transfer and storage attempts that violate an applicable rule or policy.

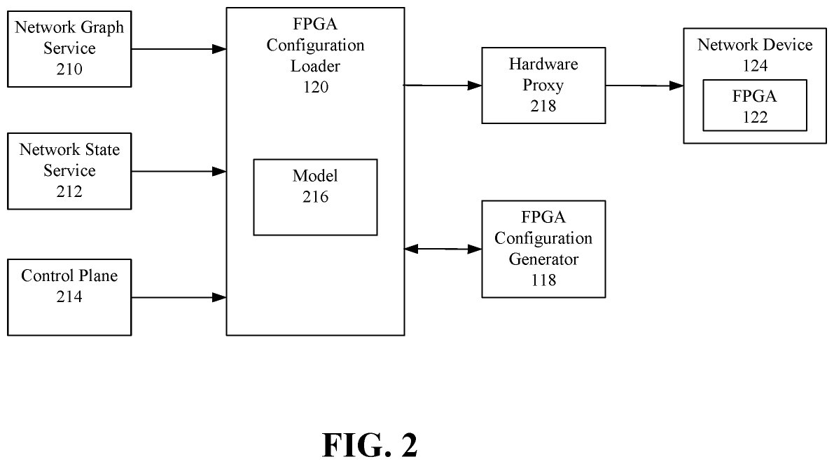

The generated configuration file is transmitted from the FPGA configuration generator 118 to the FPGA configuration loader 120. As discussed above, the FPGA configuration loader 120 retrieves the network topology for the system and provides it to the FPGA configuration generator 118. The FPGA configuration loader 120 retrieves the network topology information from various elements in a system such as the system 100, as discussed in further details with respect to FIG. 2. The FPGA configuration loader 120 is also responsible for the deployment of the proper FPGA configuration files received from the FPGA configuration generator 118 to the proper network device. Thus, the FPGA configuration loader 120 receives an FPGA configuration file from the FPGA configuration generator 118, identifies the network device 124 to which the configuration file applies and loads the configuration file onto the FPGA 122 of the network device 124. The FPGA configuration loader 120 relies on hardware proxy to access the network device 124 and request that the configuration file be loaded onto the FPGA 122. Once the configuration file is loaded onto the FPGA 122, the FPGA 122 utilizes the configuration file to directly route data in accordance with governing data rules and guidelines that are locally stored and implemented in the FPGA 122.

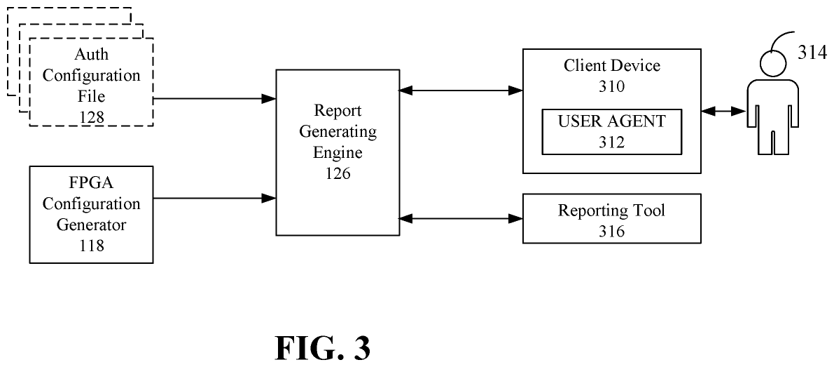

The information collected and organized by the FPGA configuration generator 118 is not only helpful for generating a configuration file for the FPGA 122 but can also be used to generate documentation about data compliance in the system 100. That is because the FPGA configuration generator 118 receives information about the policies, rules and services used in the system 100 and as such has current and accurate information about the state of data compliance in the system 100. To achieve this, the system 100 makes use of a report generating engine 126, which collects data from the FPGA configurations generator 118 and the Auth configuration file(s) 128 and uses the data to generate documentation about data privacy compliance, and the like. The Auth configuration file 128 is an authentication file that describes the configurations of a service used in the system 100, such as the service(s) 110. The auth configuration file 128 includes information about the rights needed and/or the authentication tokens required to allow a user to use the service 110 associated with the authentication file. While the auth configuration file 128 is not required for configuring the FPGA 122, the data included in the auth configuration file 128 can be used in the documentation generated for the system. For example, some of the documentations include the type of mechanism used for security and authentication of a service. By retrieving the data from the auth configuration file 128, the report generating engine 126 can include this data in the documentations generated, as needed. Further details regarding the operations of the report generating engine 126 is provided with respect to FIG. 3.

Various elements of the system 100 are connected to each other via the network (not shown). The network may be one or more wired or wireless networks or a combination of wired and wireless networks. The system 100 may be implemented in a single site or spread out in a number of buildings or geographically separated locations. The report generating engine 126 may be part of a service offered via a server and maybe a part of the system 100 or maybe a remote service.

FIG. 2 is an example of data flow between some elements illustrated in and other elements used by the system illustrated in FIG. 1. In order to obtain information about the state of the system 100, the FPGA configuration loader 120 collects data from a network graph service 210, a network state service 212 and a control plane 214. The network graph service 210 is a software application, which may be offered as a service, that provides information about various elements in the system 100. The network graph service 210 provides information about the expected state of the network in the system 100. The network state service 212 is a software application, which may be offered as a service that provides information about the observed state of the network. Together the network graph service 210 and the network state service 212 provide information about the infrastructure topology of the system 100 which includes geolocation of datacenters, associated devices, and/or networking information. This information is transmitted to the FPGA configuration generator 118, which uses the information to determine the physical location of an FPGA, and other data about an FPGA such as the model number, and the like to determine how to generate the proper configuration file for the proper FPGA. That is because each FPGA model is different in terms of memory, number of computing units, and the like, and thus requires a specific synthesis to generate a compatible configuration file.

The FPGA configuration loader 120 also retrieves data from the control plane 214, which may be a control plane engine such as the Substrate Control Plane or OpenShift® Control Plane. The control plane 214 manages where functional services such as software services are deployed in the system (e.g., in the cloud infrastructure). For example, the control plane 214 may manage and/or have information about which servers and/or datacenters are used to execute which software services in the system.

The information retrieved by the FPGA configuration loader 120 from the network graph service 210, network state service 212 and control plane 214 is used to transmit data to the FPGA configuration generator 118 and to identify which FPGA in the system should receive a given FPGA configuration file. Once it identifies the appropriate FPGA device, the FPGA configuration loader 120 utilizes the hardware proxy 218 to access the network device 124 and request a configuration load for the configuration file. The information transmitted by the FPGA configuration loader 120 to the FPGA configuration generator 118 is used by the FPGA configuration generator 118 to synthesize the proper configuration by combining the infrastructure topology with the expected policies and rules, and with the functional service API descriptions to know what data to block in which direction.

The process of retrieving data from the network graph service 210, network state service 212 and control plane 214 and transmitting the data to the FPGA configuration generator 118 is done offline. However, because rules, policies, services and/or state of the network may change from time to time, it may become necessary to update the configuration file. In some implementations, when there is a change in the expected or observed state of the network, the network graph service 210 or network state service 212, respectively, transmit the changes to the FPGA configuration loader 120. In other implementations, the FPGA configuration loader 120 retrieves data from the network graph service 210 and/or network state service 212 periodically (e.g., based on a predetermined schedule) and compares the data from previously retrieved data to determine if there are any changes. This requires the use of a storage medium on which the data retrieved from each of the network graph service 210, network state service 212 and control plane 214 may be stored. When there is a changes in the network, a determination may have to be made as to whether the changes require the creation of a new configuration file. This is achieved, in some implementations, by utilizing an artificial intelligence (AI) model such as the model 216, which may be a model that is trained to examine data about a system (e.g., changes made in the network) and determine whether the changes require that a new configuration file be generated for one or more FPGAs in the system.

FIG. 3 is an example of some elements involved in generating a data compliance document for a computing system. As discussed above, data about the rules and policies enforced by the system and information about software services executed or offered by the system are transmitted from the FPGA configuration generator 118 and auth configuration file(s) 128 to the report generating engine 126 for processing. In some implementations, the report generating engine 126 uses and combines information from the different elements in the system. For example, some of the data may be directly retrieved by the report generating engine 126 from the policy extracting engine 104, rule extracting engine 108 and/or SSOT extracting engine 114 of FIG. 1. In another example, the aggregated data is retrieved from the FPGA configuration generator 118.

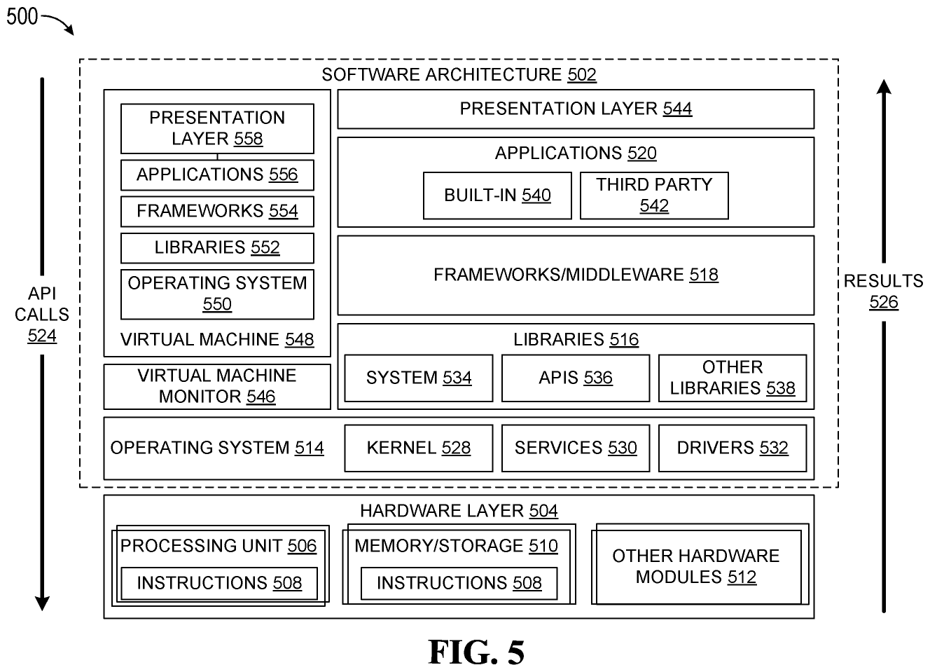

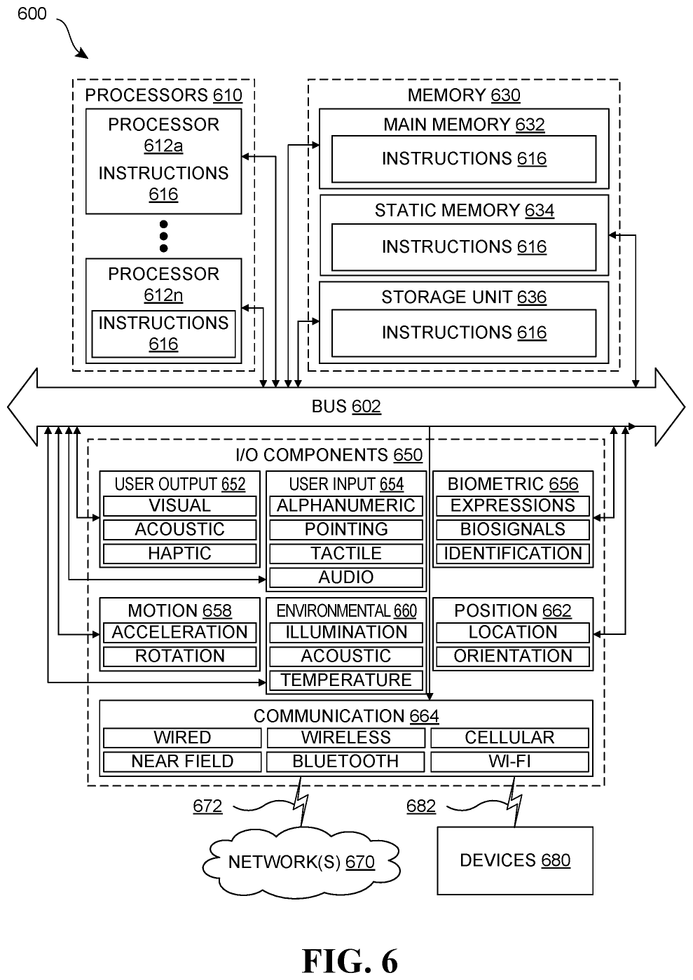

The report generating engine 126 may be a software program that is offered either as a service (e.g., via a server) or as a native application that is executed on a client device such as the client device 310. When the report generating engine 126 is offered as a service, the client device 310 utilizes the user agent 312 (e.g., a web browser) to access the report generating engine 126. A user 314 interacting with the client device 310 can make use of the report generating engine 126 to generate one or more types of data compliance documents. For example, the user can utilize a user interface screen of the report generating engine 126 to select the type of document desired. The client device 310 may be any stationary or mobile computing device configured to communicate with the report generating engine 126 and/or execute a native reporting generating engine. For example, the client devices may include workstations, desktop computers, laptop computers, tablets, phablets, smart phones, cellular phones, personal data assistants (PDA), printers, scanners, telephone, televisions smart watches, wearable computers, gaming devices/computers, head-mounted display devices or any other device. The internal hardware structure of a client device and/or a server used to execute any of the elements of FIGS. 1-3 is discussed in greater detail in regard to FIGS. 5 and 6.

A data compliance document refers to any type of document that provides information to a user about compliance with data rules, regulations and policies in a given computer environment. The type of data included in the data compliance document and/or the format in which the document is generated may vary depending on the needs of the organization and/or the user generating the document. For example, the data compliance document may be a chart, graph, spreadsheet document, word document, and any other type of document. In some implementations, the report generating engine 126 enables the user to select the types of data needed in the document. For example, the document may include the types of data being blocked from storage, the types of data transfer being blocked and the like. In some implementation, the report generating engine 126 generates documentation such as data flow diagrams and data classification lists. Furthermore, in some implementations, the report generating engine 126 transmits data to an existing reporting tool. The existing reporting tool may be any reporting software currently being used by an organization to generate data compliance reports. The report generating engine 126 may transmit the data through the API of the reporting tool 316 to enable the organization to use existing reporting tools while increasing efficiency.

In this manner, the technical solution provides a system in which runtime checks and data compliance reporting are both derived from the same single source of truth. As a result, at given time, the reporting is synchronized with what occurs in the system. This improves the quality of the documentation, ensures its consistency with the running system, and drastically reduces the cost of producing such compliance reports by reducing human intervention. Furthermore, moving the data compliance logic from software to hardware ensures that requests from business applications are checked on the network without impact on the response time due to the performance of the FPGA which can run as fast as the network can transport data. This increases efficiency and reduces the amount of network bandwidth and computing resources needed to execute the business application.

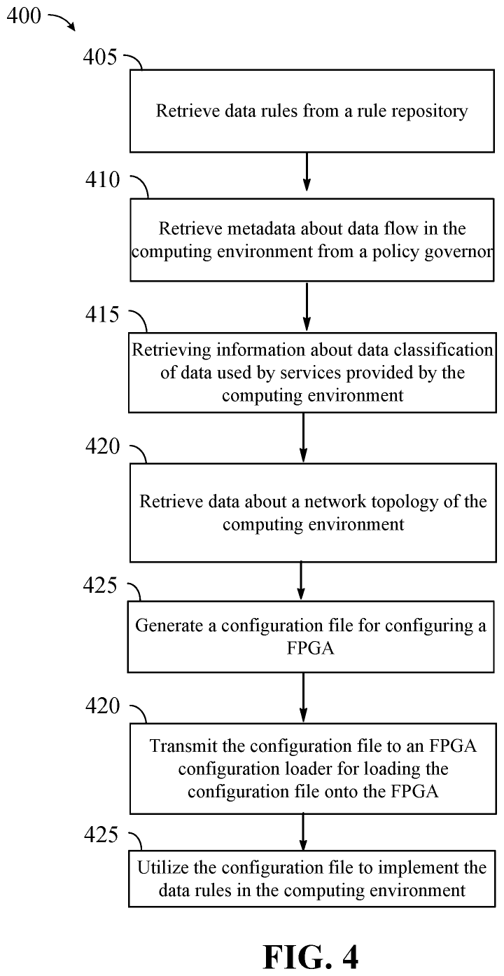

FIG. 4 is a flow diagram showing an example method for ensuring data compliance in a computer environment. In an example, one or more steps of method 400 may be performed by a FPGA configuration generator such as the FPGA configuration generator 118 of FIGS. 1-3, while other steps may be performed by an FPGA configuration loader such as the FPGA configuration loader 120 of FIGS. 1-3, policy extracting engine 104, rule extracting engine 108, or SSOT extracting engine 114.

At 405, the method 400 begins by retrieving data rules from a rule repository. The rule repository is a repository that stores one or more rules and/or policies that are associated with storage and/or transfer of data by one or more devices in a computing environment. The rules may include governmental rules and regulations and organizational policies and others. In some implementations, rules are retrieved from multiple rule repositories. For example, different rule repositories may store different types of rules. A rule extracting engine may be used to extract the rules from the rule repository and the rules may be retrieved from the rule extracting engine by the FPGA configuration generator.

In addition to retrieving data rules, method 400 also retrieves metadata about data flow in the computing environment from a policy governor, at 410. The metadata may relate to whether a data flow is user, service or administrator initiated. The policy governor may be an entity that stores specific sets of policies that define which rules are applied to different types of data flow. This is achieved, in some implementations by storing metadata (e.g., user initiated or not user initiated, data targeting a younger audience, with payment or not with payment, etc.) that classifies the types of data flows encountered in the system. The metadata is stored by the policy governors and used to determine how to match a data flow to the rules that should be applied to it. In some implementations, metadata is retrieved from multiple policy governors. For example, different policy governors may store different types of policies. A policy extracting engine may be used to extract the metadata from the policy governor and the metadata may then be retrieved from the policy extracting engine by the FPGA configuration generator.

Method 400 also involves retrieving information about the data classification of data used by one or more services provided by the computing environment, at 415. The data may be extracted by an SSOT extracting engine from one or more data sources associated with services provided in the computer environment and stored in a data store. This data may be later retrieved from the data store by the FPGA configuration generator.

In addition to the data rules, metadata and information about the data classification of data used by the services of the computing environment, method 400 also retrieves data about a network topology of the computing environment, at 410. This information may provide information about the location of FPGAs in the system, the networking devices in the system and the types of services and/or data routed through each network device. The information about the network topology may be retrieved by an FPGA configuration loader and then transmitted to or collected by the FPGA configuration generator.

When the required information is retrieved, method 400 proceeds to generate a configuration file for configuring an FPGA of the computing environment based on the data rules, metadata, data about the network and information about the data classification of data used by the one or more services provided by the computing environment. This is done by the FPGA configuration generator. Once the configuration file is generated, the generated configuration file is transmitted to the FGPA configuration loader for loading the configuration file onto the FPGA for which the configuration file was generated, at 420. Method 400 then utilizes the configuration file loaded onto the FPGA to implement the data rules in the computing environment, at 425.

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

In the foregoing detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
retrieving data rules from a rule repository, the rule repository being a repository that stores one or more rules that are associated with at least one of storage or transfer of data by one or more devices in a computing environment;
retrieving metadata about data flow in the computing environment from a policy governor;
retrieving information about a data classification of data used by one or more services provided by the computing environment;
retrieving data about a network topography of the computing environment;
generating a configuration file for configuring a Field Programmable Gate Array (FPGA) based on at least one of the data rules, the metadata, the data about the network and the information about the data classification of data used by the one or more services provided by the computing environment; and
transmitting the configuration file to a FPGA configuration loader for loading the configuration file onto the FPGA,
wherein the FPGA utilizes the configuration file to implement the data rules in the computing environment.

2. The data processing system of claim 1, wherein the data rules are extracted from the rule repository by a rule extracting engine and retrieved from the rule extracting engine by a FPGA configuration generator.

3. The data processing system of claim 1, wherein the metadata are extracted from the policy governor by a policy extracting engine and retrieved from the policy extracting engine by a FPGA configuration generator.

4. The data processing system of claim 1, wherein the information about the data classification of data used by the one or more services provided by the computing environment is extracted from one or more data sources associated with the one or more services via a Single Source of Truth (SSOT) extracting engine.

5. The data processing system of claim 4, wherein the information extracted via the SSOT engine is used to store a SSOT document for the computing environment in a data store.

6. The data processing system of claim 1, wherein the FPGA utilizes the configuration file to route data in the computing environment in accordance with the data rules.

7. The data processing system of claim 1, wherein the data about the network topography of the computing environment is retrieved from the FPGA configuration loader.

8. The data processing system of claim 1, wherein the FPGA configuration loader receives data from at least one of a network graph service, a network state service, and a control plane to generate the data about the network topography of the computing environment.

9. The data processing system of claim 1, wherein the FPGA configuration loader utilizes an artificial intelligence model to determine whether a new configuration file should be generated for the FPGA.

10. The data processing system of claim 1, wherein the FPGA configuration loader utilizes a hardware proxy to load the configuration file onto the FPGA.

11. A method for ensuring data compliance in a computer environment, comprising:
retrieving data rules from a rule repository, the rule repository being a repository that stores one or more rules that are associated with at least one of storage or transfer of data by one or more devices in the computing environment;
retrieving metadata about data flow in the computing environment from a policy governor;
retrieving information about a data classification of data used by one or more services provided by the computing environment;
retrieving data about a network topography of the computing environment;
generating a configuration file for configuring a Field Programmable Gate Array (FPGA) based on at least one of the data rules, the metadata, the data about the network and the information about the data classification of data used by the one or more services provided by the computing environment; and
transmitting the configuration file to a FPGA configuration loader for loading the configuration file onto the FPGA,
wherein the FPGA utilizes the configuration file to implement the data rules in the computing environment to ensure data compliance in the computing environment.

12. The method of claim 11, further comprising:
providing at least one of the data rules, the metadata, the data about the network, the information about the data classification of data used by the one or more services provided by the computing environment and one or more auth configuration files associated with the one or more services to a report generating engine,
wherein the report generating engine utilizes at least one of the provided at least one of the data rules, metadata, data about the network, information about the data classification of data used by the one or more services provided by the computing environment and authorization configuration data associated with the one or more services to the report generating engine to generate one or more data compliance documents.

13. The method of claim 12, wherein the report generating engine is a software service or software application for generating data compliance documents.

14. The method of claim 12, wherein the report generating engine generates a user selected type of data compliance document.

15. The method of claim 12, wherein the report generating engine enables a user to select one or more types of data points to be included in a data compliance document.

16. The method of claim 12, wherein the report generating engine transmits the one or more data compliance documents to a reporting tool.

17. A non-transitory computer readable medium on which are stored instructions that when executed cause a programmable device to perform functions of:
retrieving data rules from a rule repository, the rule repository being a repository that stores one or more rules that are associated with at least one of storage or transfer of data by one or more devices in a computing environment;
retrieving metadata about data flow in the computing environment from a policy governor;
retrieving information about a data classification of data used by one or more services provided by the computing environment;
retrieving data about a network topography of the computing environment;
generating a configuration file for configuring a Field Programmable Gate Array (FPGA) based on at least one of the data rules, the metadata, the data about the network and the information about the data classification of data used by the one or more services provided by the computing environment; and
transmitting the configuration file to a FPGA configuration loader for loading the configuration file onto the FPGA,
wherein the FPGA utilizes the configuration file to implement the data rules in the computing environment.

18. The non-transitory computer readable medium of claim 17, wherein the FPGA configuration loader utilizes a hardware proxy to load the configuration file onto the FPGA.

19. The non-transitory computer readable medium of claim 17, wherein the FPGA is included in a network device of the computing environment, the network device being used to route data in the computing environment.

20. The non-transitory computer readable medium of claim 17, wherein the computing environment includes a plurality of FPGAs and the FPGA configuration loader determines which configuration file to load onto each of the plurality of FPGAs.
